(19) United States
(12) Patent Application Publication
(10) Pub. No.: US 2011/0096094 A1
(43) Pub. Date: Apr. 28, 2011

(54) DISPLAY DEVICE AND METHOD OF OPERATING THE SAME

(76) Inventor: Seong-Woon Seol, Gyeonggi-do (KR)

(21) Appl. No.: 12/673,308

(22) PCT Filed: Aug. 14, 2008
(86) PCT No.: PCT/KR2008/004749

§ 371 Date: Jan. 10, 2011

(30) Foreign Application Priority Data
Aug. 14, 2007 (KR) 10-2007-0081629

(51) Int. Cl. G09G 5/00

(52) U.S. Cl. 345/634; 345/619

(57) ABSTRACT

A display device and a method of operating the display device are provided. The display device includes a media interface unit for receiving images through an external memory card, a memory unit for storing the images therein, a network interface unit for receiving related contents from an external server using image taking time information and GPS information contained in the images, and a controller displaying the images together with the contents provided through the network interface unit with reference to the image taking time information and the GPS information.

### TECHNICAL FIELD

The present disclosure relates to a display device, and more particularly, to a display device that has an electronic album function such as a slideshow function.

### BACKGROUND ART

Display devices that can sequentially display two or more images taken by a digital camera and the like have been increasingly used.

However, the related art display device provides only a slideshow function that can display the images taken by a user in accordance with edited order and thus it cannot provide esthetic appreciation and interest to the user.

### DISCLOSURE OF INVENTION

### Technical Problem

Embodiments provide a display device that can not only reproduce images taken by a user but also provide video or audio contents related to the images and a method of operating the display device.

Embodiments also provide a display device that has a panorama output function that can satisfy a variety of user s request and a method of operating the display device.

### Technical Solution

In one embodiment, a display device includes a memory unit for storing images containing GPS information and a controller for arranging and displaying the images with reference to the GPS information.

In another embodiment, the display device includes a media interface unit for receiving images through an external memory card, a memory unit for storing the images therein, a network interface unit for receiving related contents from an external server using image taking time information and GPS information contained in the images, and a controller displaying the images together with the contents provided through the network interface unit with reference to the image taking time information and the GPS information.

In still another embodiment, a display device includes a memory unit for storing images containing GPS information and image taking time information, a controller for sequentially displaying first and second images stored in the memory unit in accordance with the GPS information or the image taking time information, and a display unit for displaying the first and second images, wherein the controller forms an image taking route of the images using the GPS information and the image taking time information and displays an image for the image taking route on the display unit.

In still yet another embodiment, a method of operating a display device that can be connected to a memory card storing image data therein includes reading the image data stored in the memory card and image taking time information and GPS information for the image data, transferring the read GPS information to an external content server and downloading contents from the content server, and arranging and displaying the image data and the contents in accordance with the image taking time information or the GPS information.

### ADVANTAGEOUS EFFECTS

According to the embodiments, since not only the images that are not taken by the user or the scene sounds but also the data related to the images can be provided from the content server, the user's satisfaction can be improved.

In addition, since the images are provided by the slideshow function and a variety of contents are additionally provided, a variety of user's requests can be satisfied.

The details of one or more embodiments are set forth in the accompanying drawings and the description below. Other features will be apparent from the description and drawings, and from the claims.

### BRIEF DESCRIPTION OF THE DRAWINGS

FIG. 1 is a view of a system according to an embodiment.

FIG. 2 is a view of a display device according to an embodiment.

FIG. 3 is a view illustrating a reconstruction of image data according to an embodiment.

FIG. 4 is a view of a virtual map including a main screen and a sub-screen according to an embodiment.

FIG. 5 is a view of an example of a main screen constituting a virtual map according to an embodiment.

FIG. 6 is a view of an example of a sub-screen constituting a virtual map according to an embodiment.

FIG. 7 is a flowchart illustrating an operation of a display device according to an embodiment.

### BEST MODE FOR CARRYING OUT THE INVENTION

Reference will now be made in detail to the embodiments of the present disclosure, examples of which are illustrated in the accompanying drawings. As those skilled in the art would realize, the described embodiments may be modified in various different ways, all without departing from the spirit or scope of the disclosure. Various variations and modifications will be possible in the component parts and/or arrangements of the subject combination arrangement within the scope of the disclosure of the embodiments.

Further, when it is described that a member includes” an element, this means that the member may further include another element unless specified to the contrary.

FIG. 1 is a view of a system according to an embodiment.

Referring to FIG. 1, display devices 10, 11, and 12 each having an electronic album can be connected to a content server 200 through the internet. When there is a content download request from the display device, the content server 200 transfers corresponding contents. When there is a content upload request from the display device, the content server 200 stores corresponding contents therein.

That is, each of the display devices 10, 11, and 12 is designed to download or upload the contents through the internet. The contents may be images that can be displayed by the display devices. The contents may further include information on a time at which the image is taken or global positioning system (GPS) information.

In addition, the contents uploaded to the content server 200 may be downloaded to a desired other display device. In this case, it becomes possible that users of the respective display devices can share the contents.

However, the range of the users who can share the contents may be managed by the content server 200 and this can be performed in accordance with the setting of the users using the contents server 200.

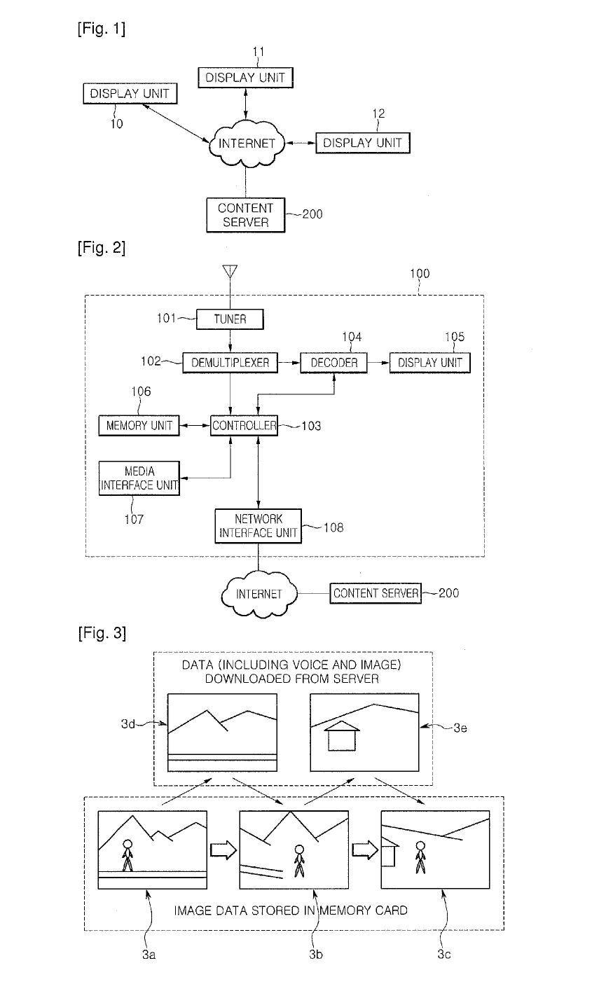

FIG. 2 is a view of a display device according to an embodiment.

Referring to FIG. 2, a display device 100 includes a tuner 101 for selecting a radio signal, a demultiplexer 102 for demultiplexing the selected signals, a decoder 104 for decoding the video signals demultiplexed by the demultiplexer 102, a display unit 105 for outputting the decoded video signals, and a media interface unit 107 for receiving the contents from an external storage unit or an image taking unit, a network interface unit 10R for connecting to an external content server 200 through the internet, memory unit 106 for storing the contents from the media interface unit 107 or the network interface unit 108 therein, and a controller 103 for controlling the contents stored in the memory unit 106 such that the contents can be output to the display unit 105.

The tuner 101 receives the radio signals in accordance with the selection command from the controller 103, performs a high frequency process or a modulating process for the received radio signals, and outputs the processed radio signals to the demultiplexer 102 as a transport stream.

The demultiplexer 102 divides the transport stream from the tuner 101 into additional information such as program information and digital video and sound signals that are MPEG data. Then, the demultiplexer 102 outputs the MPEG data to the decoder 104 and also outputs the additional information to the controller 103.

When the decoder 104 attains image processing request from the controller 103, the decoder 104 decodes the MPEG data from the demultiplexer 102 and outputs the decoded MPEG data to the display unit 105 as the video signals. Meanwhile, when the decoder 104 attains the picture processing request from the controller 103, the decoder 104 decodes the video data from the controller 103 and outputs the decoded video data to the display unit 105 as the picture signals.

The media interface unit 107 may be an external storage unit or an image taking unit itself or function to interface the external storage unit such as a USB memory or an SD card to the display unit 100.

In addition, in the embodiment, it is assumed that the contents or images provided through the media interface unit 107 are data recorded by the digital camera or the like based on a file format standard (Exit) for the digital camera.

A method for classifying images in an event is to use information on places using GPS information. The GPS information can be attained when the digital camera has a GPS function and described by a tag where the attained information is contained in Exif IFD.

That is, it is defined in accordance with the embodiment that the contents or images include image data and information on an image taking date/time and GPS. The contents may further include information on resolution, file compression type, pixels, and the like or information on image taking conditions, or information on object distances or shutter speeds.

Therefore, in the following description, it is regarded that the contents or images include the image data and information on the image taking date/time and GPS.

Meanwhile, the display device 100 includes the network interface unit 108 for connecting to the external content server 200 through the internet. By the network interface unit 108, the contents stored in the memory unit 106 can be uploaded or the contents stored in the content server 200 can be downloaded.

The following will describe the operation of the display device structured as described above.

First, a database that is designed to provide scene images and recorded scene sounds to the display device 100 is structured in the content server 200.

That is, the contents server 200 is provided with the database having scene images of each province that can be classified in accordance with the GPS information. In addition, the database may further have scene sounds of each province.

Therefore, when the GPS information on a specific image is transferred from the display device 100, the content server 200 can provide scene images or sounds of corresponding or adjacent province to the display device using the GPS information.

Here, the content server 200 may be constructed at a DTV portal 365 that is currently running.

In addition, the media interface unit 107 of the display device 100 performs the interface as the memory card (not shown) is inserted so that the additional information (a serial number of the memory card, a file name, a file size, a generation data, GPS information, and the like) and the image data can be stored in the memory unit 106. The memory card may be a memory unit of an image taking unit such as a digital camera.

Here, the controller 103 receives the images and GPS information read from the memory card and aligns and stores the images in the memory unit 106 using the GPS information.

In addition, the controller 103 transfers the GPS information contained in the images provided through the media interface unit 107 to the content server 200 through the network interface unit 108 and extracts the images related to the GPS information from the content server 200, after which the controller 103 transfers the extracted images to the display device 100 through the interne (network).

That is, the display device 100 transfers the GPS information to the contents server 200 and receives the related images and sound signals from the content server 200.

Here, the related images from the content server 200 may be scene images of a province corresponding to the GPS information and the related sound signals may be scene sounds of the province corresponding to the GPS information.

In addition, the controller 103 of the display device 100 stores the video signals or sound signals from the network interface 108 in the memory unit 106.

Depending on users, the images in the memory card connected to the media interface unit 107 may be stored in the memory unit 106 of the display device and the images in the memory card can be directly displayed through the slideshow.

Therefore, if necessary, the controller 103 of the display device 100 stores the images or sound signals downloaded through the network interface unit 108 in the memory unit 106 and performs the slideshow function by reading the image data from the memory card.

In order to perform the slideshow for the images, the controller 103 may reconstruct the image data read from the memory card and the images or sound information stored in the memory unit 106 and provided from the contents server 200 in chronological order or in accordance with the GPS information.

This will be described in more detail with reference to FIG. 3.

FIG. 3 is a view illustrating a reconstruction of image data according to an embodiment.

Referring to FIG. 3, first, second, and third images 3a, 3b, and 3c are illustrated as image data stored in the memory card. Fourth and fifth images 3d and 3e are illustrated as the image information from the content server 200.

As previously described, the fourth and fifth images 3d and 3e are provided from the content server 200 based on the GPS information for the first to third images 3a, 3b, and 3c.

When the user of the display device selects the slideshow function, the controller 103 of the display device sets a display order as follows: the first image 3a the fourth image 3d the second image 3b the fifth image 3e—the third image 3c.

That is, the fourth image 4d is an image having the related province information to the GPS information on the first and second images 3a and 3b.

For example, the content server 200 provides the image of the most related province to the location corresponding to the first and second images 3a and 3b using the GPS information on the images. When there are two or more images of the most related province to the location corresponding to the first and second images 3a and 3b, the more popular image may be provided.

Meanwhile, according to the embodiment, it is also possible to provide a virtual map to the user using an image taking time information or GPS information contained in the content or image. The virtual map includes a moving path using the GPS information and the image list downloaded from the content server.

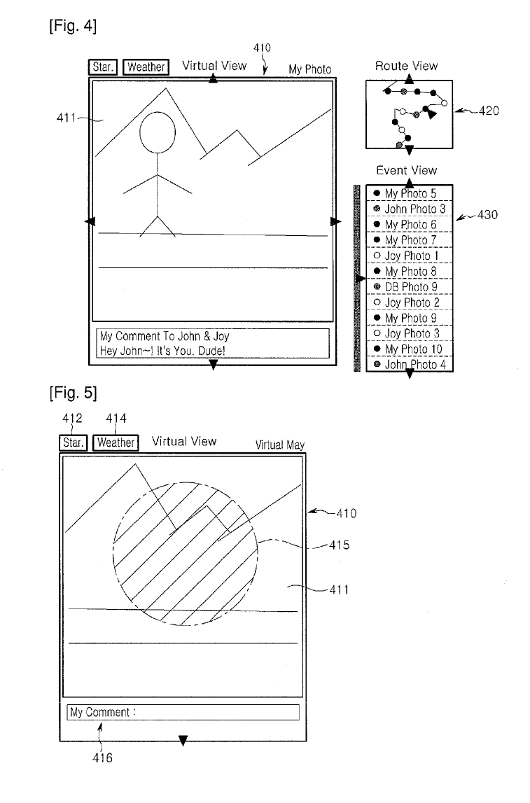

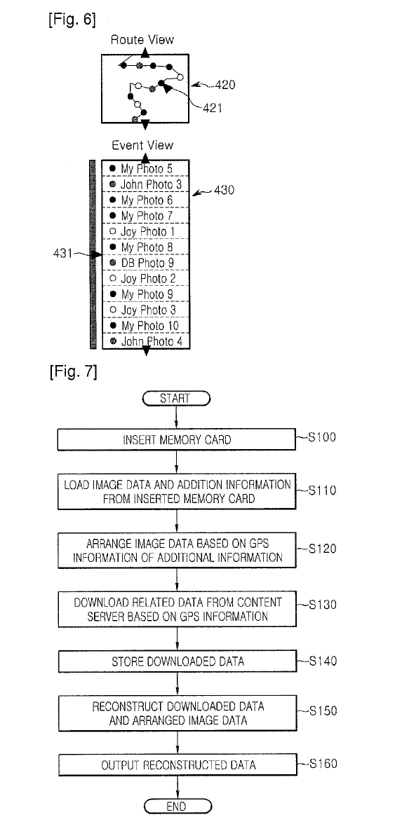

FIG. 4 is a view of a virtual map including a main screen and a sub-screen according to an embodiment, FIG. 5 is a view of an example of a main screen constituting a virtual map according to an embodiment, and FIG. 6 is a view of an example of a sub-screen constituting a virtual map according to an embodiment.

A virtual map illustrated in FIGS. 4 to 6 illustrates an embodiment of a slideshow function providing screen displaying the images in accordance with the control of the controller when the user of the display device wishes to use the slideshow function to view the images stored in the memory card.

The following will describe the slideshow function of the display device that can provide additional services to the user in addition to the features where the images provided from the content server are inserted between the images taken by the user or his/her friends in accordance with the GPS information or image taking time.

FIG. 4 illustrates a main screen 410 displaying the image taken, a first sub-screen displaying an image taking route using the GPS information or image taking time contained in the image, and a second sub-screen 430 displaying the information on an image owner or image provider displayed on the main screen 410.

The main screen 410 displays the image data of the content provided through the media interface unit 107 or the network interface unit 108 of the display device. The first and second sub-screens 420 and 430 forms the content taking route or displays the information of the content provider using the image taking time information or GPS information contained in the content.

The virtual map may be displayed between the first and second images taken by the user or a virtual map view function may be further provided in addition to the slideshow function.

Referring to FIGS. 4 and 5, the main screen 410 displays the image 401 taken. A variety of additional functions for the image 401 are provided.

According to the embodiment, the display device determines weather information or astronomical information corresponding to the GPS information and the image taking time information and subsequently outputs the audio or video content representing the weather information or astronomical information to the slideshow function providing screen. That is, when the display device transfers the image taking time information and the GPS information contained in the content to the content server 200, the content server 200 transfers the weather or astronomical information of the related province at the related time to the display device using the image taking information and the GPS information.

The content provided from the content server 200 may be not only a still image but also a motion picture that is a video content or an effect sound or scene sound of the related location that is an audio content.

Therefore, the audio content provided from the content server 200 may be output through an audio output unit of the display device while an image file is being output or turned. The video content may be output when the user pushes separate buttons 412 and 414 or output at a predetermined area in the slideshow function screen or the background screen of the image file.

For example, when the taking time of the first image is 15:00, Nov. 1, 2007, the display device determines the weather information as Rain at the related time at the related province to the GPS information of the first image and outputs the audio or video content corresponding to the ‘Rain’ to the screen.

In this case, as shown in the drawings, the display device displays the raining image 415 inserted in the corresponding image.

Likewise, the display device receives astronomical information corresponding to the GPS information and image taking time information, i.e., the astronomical information of the related image taking time and related province from the content server and outputs the received astronomical information to the video content.

Therefore, by the above embodiment, the user can enjoy the content while identifying the weather information or the astronomical information of the province and time where the image is taken by the user.

In addition, the display device receives comments on the image file, which is being output, from a separate input window 416 and displays the comments on the main screen 410. When the user inputs the comments through the input window 416, other users can view the comments through the virtual map.

For example, the user can download the pictures taken by friends who traveled together at the display device and arranges the downloaded pictures in the chronological order. In addition, the user can identify the travel route through the virtual map as well as the comments input by himself/herself or friends.

The travel route in accordance with an image taking route analysis using the image taking time information or the GPS information contained in the content provided to the display device is displayed on the first sub-screen 420.

Figures for the respective contents are displayed in the chronological order or the location order using the GPS information or image taking time information contained in the respective contents.

Here, the contents may be contents stored in the memory card connected to the display device, contents pre-stored in the memory unit of the display device, or contents downloaded from the content server.

In addition, the content provider information is displayed on the second sub-screen 430. The information on the content provider is arranged on the second sub-screen 430. In the drawing, DB photo indicates content provided from the content server, Joy photo and John photo indicate contents provided from the friends of the user.

In addition, the display device may display predetermined pointers 421 and 431 as marks for the corresponding contents on the first and second sub-screens 420 and 430. In this case, when a plurality of images are turned by the slideshow, the pointers 421 and 431 are displayed together in the corresponding figures and corresponding user list and thus the user can attain the content information by sight.

FIG. 7 is a flowchart illustrating an operation of a display device according to an embodiment.

The user inserts the memory card containing image data taken by the user when the user travels (S100).

Next, the controller of the display device reads the image data and additional information including the image taking time information or the GPS information from the inserted memory card (S110).

Further, the images of the image data are arranged in chronological order or special order using the GPS information or the image taking time information (S120).

Next, the GPS information is transferred to the content server 200 through the network interface unit 108 and the related video content or the audio content is received from the content server 200 (S130).

The provided content is stored in the memory unit 106 of the display device and the arranged image data and the content provided from the server are reconstructed in order of moving route or image taking time (S150). Next, the reconstructed image is displayed and, at the same time, the sound is output (S160). In the slideshow display, the virtual map is further displayed so that the user can attain a variety of additional information.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The present invention can be applied to the display device that can display an image and thus the industrial applicability is high.

1. A display device comprising:
a memory unit for storing images containing GPS information; and
a controller for arranging and displaying the images with reference to the GPS information.

2. The display device according to claim 1, wherein the images stored in the memory unit comprise a first image taken by a digital camera and a second image downloaded from an external content server.

3. The display device according to claim 1, wherein the memory unit stores therein first and second images that can be classified in accordance with a storing path of image data; and
the controller arranges and displays the first and second images using a slideshow function in accordance with the GPS information.

4. A display device comprising:
a media interface unit for receiving images through an external memory card;
a memory unit for storing the images therein;
a network interface unit for receiving related contents from an external server using image taking time information and GPS information contained in the images; and
a controller displaying the images together with the contents provided through the network interface unit with reference to the image taking time information and the GPS information.

5. The display device according to claim 4, wherein the controller displays the images and contents in location order in accordance with the GPS information or in chronological order in accordance with the image taking time information.

6. The display device according to claim 4, wherein, when audio contents corresponding to the GPS information is received through the network interface unit, the controller stores the audio contents in the memory unit and outputs the audio contents when displaying the images stored in the memory unit.

7. The display device according to claim 4, wherein the contents provided through the network interface unit include image data and information on an image data provider; and
the controller displays the information on the image data provider together with the image data.

8. A display device comprising:
a memory unit for storing images containing GPS information and image taking time information;
a controller for sequentially displaying first and second images stored in the memory unit in accordance with the GPS information or the image taking time information; and
a display unit for displaying the first and second images,
wherein the controller forms an image taking route of the images using the GPS information and the image taking time information and displays an image for the image taking route on the display unit.

9. The display device according to claim 8, wherein the controller displays a virtual map including the image for the image taking route in a state where the virtual map is inserted between the first and second images in a slideshow function.

10. The display device according to claim 9, wherein the virtual map includes a main screen for displaying one of the first and second images and a sub-screen for display information on the image taking route; and
the sub-screen further displays thereon a pointer for representing a route location on one of the first and second images.

11. The display device according to claim 8, wherein the memory unit further stores therein contents corresponding to the GPS information or image taking information of the first or second image; and
the controller, when the contents are video contents, displays an image on the image taking route on the virtual map, and, when the contents are audio contents, outputs the contents when displaying the first or second image.

12. The display device according to claim 8, wherein the first and second images include information on an image provider; and
the controller displays the information on the image provider when displaying the image of the image taking route.

13. A method of operating a display device that can be connected to a memory card storing image data therein, the method comprising:
reading the image data stored in the memory card and image taking time information and GPS information for the image data;
transferring the read GPS information to an external content server and downloading contents from the content server; and
arranging and displaying the image data and the contents in accordance with the image taking time information or the GPS information.

14. The method according to claim 13, wherein the displaying of the image data and the downloaded contents comprises, when the contents are video contents, displaying the video contents in a state where the video contents are inserted between the image data or in a state where the video contents are on the image data.

15. The method according to claim 13, wherein the displaying of the image data and the downloaded contents comprises, when the contents are audio contents, outputting the audio contents while displaying the image data.

16. The method according to claim 13, further comprising, after downloading the contents, sequentially arranging the image data and the contents in accordance with the image taking time information or the GPS information.

17. The method according to claim 13, wherein the displaying of the image data and the downloaded contents comprises displaying the image data together with an image taking route that is attained using the GPS information contained in the contents.
